(19) United States
(12) Patent Application Publication
(10) Pub. No.: US 2013/0276497 A1
(43) Pub. Date: Oct. 24, 2013

(54) Roll Forming Machine and Method of Roll Forming

(71) Applicant: Lars Ingvarsson, Borlange (SE)

(72) Inventor: Lars Ingvarsson, Borlange (SE)

(21) Appl. No.: 13/976,770

(22) PCT Filed: Nov. 21, 2011
(86) PCT No.: PCT/SE11/00208

§ 371 Date: Jun. 27, 2013

(30) Foreign Application Priority Data
Dec. 28, 2010 (SE) 1001228-4

(51) Int. Cl. B21D 5/08; B23Q 15/14

(52) U.S. Cl. CPC B21D 5/083; B23Q 15/14
USPC 72/12.8; 72/181; 72/372

(57) ABSTRACT

When roll-forming a blank into a profile having varying width and upright sides, the vertical position of at least any one of the forming roll pairs (21, 22; 23, 24) is varied 5 on either side during the roll-forming operation while the lateral and rotational positions thereof are simultaneously varied. The profile can thus be given a flat bottom during the roll-forming operation itself.

### FIELD OF THE INVENTION

The invention relates to a method of forming a flat blank into a product with a central bottom part having a width that varies along the length of the product and upright sides and to a roll-forming machine comprising two rows of forming roll pairs which are movable laterally and rotationally.

### BACKGROUND OF THE INVENTION

Roll-forming machines for roll-forming operations of this kind are known from a number of publications. DE 20 2009 007 527 U1 describes a roll-forming machine of this kind provided with separate devices for making the central bottom part flat in the longitudinal direction since the roll-forming operation does not produce a flat central bottom part. Other patent publications also describe devices for making the bottom part flat with the aid of devices separate from the forming roll pairs.

Aim of the invention and brief description of the invention The aim of the invention is to reduce or completely eliminate the incidence of the roll-forming pairs producing a central bottom part that is not flat in the longitudinal direction. This is achieved in principle by varying the vertical position of any one or more of the forming roll pairs during the roll-forming operation while simultaneously varying the lateral and rotational positions thereof. The invention is defined by the claims.

### BRIEF DESCRIPTION OF THE DRAWINGS

FIG. 1 shows several steps for the manufacture of a profile from a flat blank by roll-forming.

FIG. 2 is a diagrammatic view showing four roll-forming pairs in two working positions.

FIG. 3 is a diagrammatic view showing four roll-forming units in two working positions.

FIG. 4 is a cross section through a roll-forming station as viewed in the direction indicated by the arrows 4-4 in FIG. 5.

FIG. 5 is a partly sectional top view as viewed in the direction indicated by the arrows 5-5 in FIG. 4.

FIG. 6 shows a flat blank for a product having a convexly curved shape by way of example.

FIG. 7 is a longitudinal view of a finished product having a convex shape manufactured without using the invention.

FIG. 8 shows a blank for a product having a concavely curved shape by way of example.

FIG. 9 is a longitudinal view of a finished product having a concave shape manufactured without using the invention.

### DETAILED DESCRIPTION OF THE INVENTION

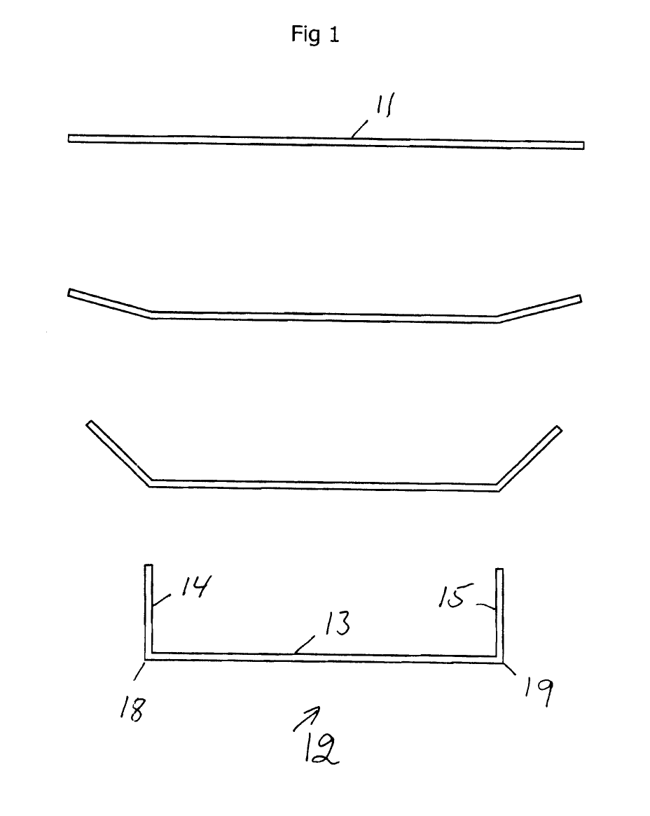

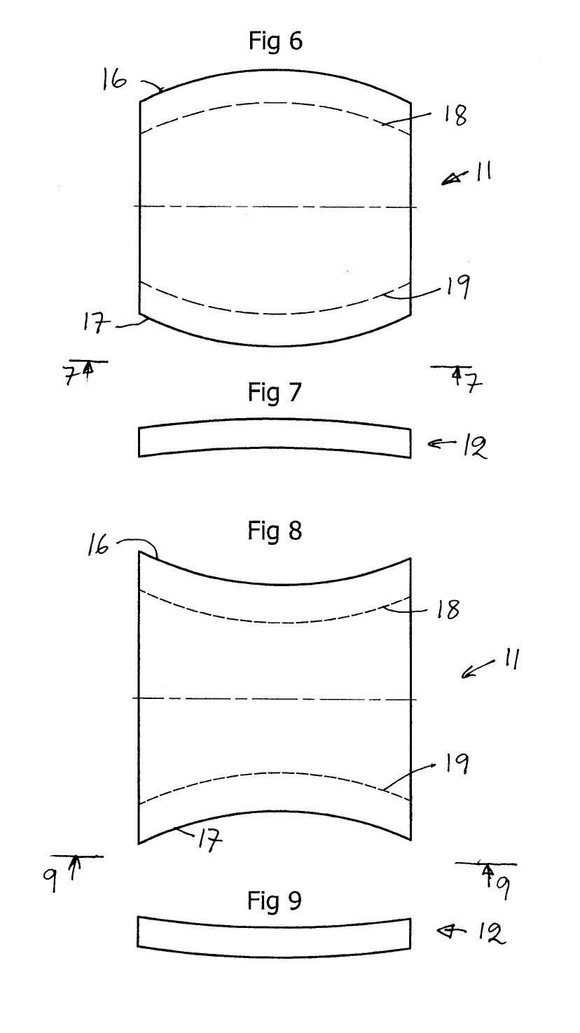

FIG. 1 shows by way of example three of the forming steps when roll-forming a flat blank 11 into a product in the form of a sheet-metal beam 12 with a flat bottom 13 and two upright sides 14, 15. In practice, there are often more steps than those shown. A product of this kind is normally bent in, e.g. six steps. FIGS. 6 and 8 show blanks 11 the outer edges of which have a radius and the broken lines 18, 19 show the lines along which the corners 18, 19 in FIG. 1 are to be bent.

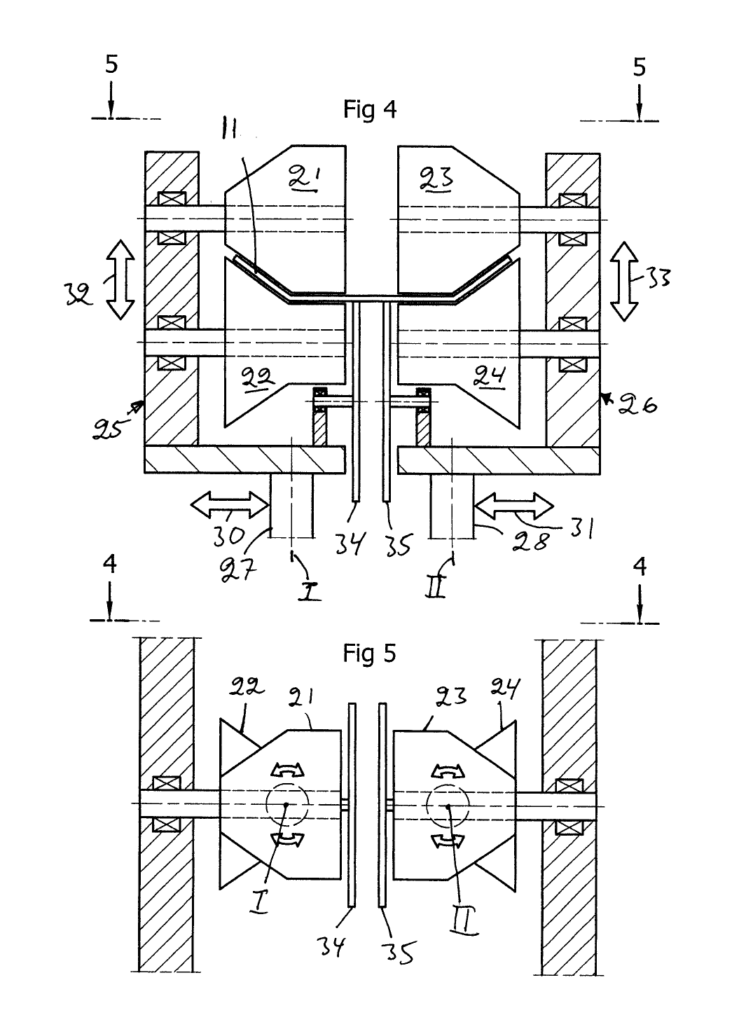

FIG. 4 shows one of the forming stations. It has two pairs of forming rolls 21, 22 and 23, 24 which clamp the semi-formed blank 11 between them. The forming station has two stand units 25, 26 and the forming roll pairs are mounted therein. The stand units have vertical journals 27, 28 which support the stand units and are mounted in a base (not shown) in such a manner that the stand units can rotate about vertical axes I and II. The journals 27, 28 can be displaced laterally in the base as indicated by the arrows 30, 31 and they are movable vertically as indicated by the arrows 32, 33. All of the movements are motor-driven and computer-controlled, although the driving devices are not shown. The forming roll pairs 21, 22 and 23, 24 can thus be displaced laterally and vertically during the roll-forming process and they can moreover be rotated about the axes I and II. Any one or more of the forming rolls is/are driven and advance/s the blank through the machine.

The stand units are provided with measuring wheels 34, 35 mounted in the stand units in such a manner that they follow all of the movements of the forming roll pairs. The measuring wheels bear against the blank 11 and measure the displacement of the blank through the roll pairs. The positions of the forming roll pairs are controlled by the position of the blank in the respective roll pairs and at least the first and the last roll pairs should be provided with measuring wheels. The guiding operation is simplified if all of the roll pairs are provided with measuring wheels.

FIG. 6 shows a blank 11 having a convex shape, wherein the lines along which the corners 18, 19 are to be formed are indicated by broken lines designated by the same reference numerals as the corners. In this example, the blank has a convexly curved shape with a constant radius. A blank of this kind having a convex shape in order to produce a profile 12 having upright sides as shown in FIG. 1 tends to give the finished product an upwardly curved shape when viewed from the side, as shown in FIG. 7.

FIG. 8 shows a blank 11 which instead has a concave shape. A blank of this kind having a concave shape in order to produce a profile having upwardly bent sides tends instead to give the finished profile 12 according to FIG. 1 a downwardly curved shape when viewed from the side, as shown in FIG. 9.

In order to prevent the finished product from being curved in the vertical plane, i.e. in order to prevent its bottom 13 in FIG. 1 from being curved, as shown in FIGS. 7 and 9, according to the invention, any one or more of the forming roll pairs can be displaced vertically during the roll-forming process.

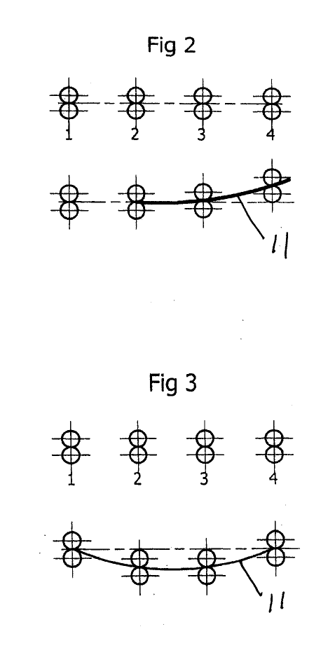

FIG. 2 shows the roll-forming in four roll pairs 1, 2, 3, 4 of a blank having a convex shape according to FIG. 6 which tends to be curved downwards, i.e. to result in an upwardly curved shape as shown in FIG. 7. Raising the last forming roll pair in each row, i.e. the roll pairs 4, during the roll-forming operation and thereby bending the product upwards prevents the formation of the curved shape and the finished product has a flat bottom.

FIG. 3 shows an alternative method of preventing the product from being curved. Instead of raising the last roll pairs 4, the roll pairs 2 and 3 situated between the first and the last roll pairs are lowered, thereby bending the blank upwards during the forming operation, i.e. into a downwardly curved shape, before it is given its final shape and the finished product has a flat bottom.

When roll-forming a blank having a concave shape according to FIG. 8 instead of a blank having a convex shape according to FIG. 6, the forming roll pairs are guided in the opposite manner to that shown in FIGS. 2 and 3.

1. Roll forming machine comprising two rows of forming roll pairs (21, 22; 23, 24) for forming a flat blank (11) into a product (12) with a central bottom part (13) having a width that varies along the length of the product and upright sides (14, 15), the forming roll pairs being movable laterally and rotationally, wherein
at least any one of the forming roll pairs (21, 22; 23, 24) in each row is movable vertically and is designed in such a manner that it can be guided vertically while simultaneously being guided laterally and rotationally and in that a measuring device (34, 35) for recording the advance of the blank is associated with this forming roll pair and is designed to follow the vertical movement thereof.

2. Roll forming machine according to claim 1, wherein said any one of the roll-forming pairs (21, 22; 23, 24) is the last roll-forming pair.

3. Roll-forming machine according to claim 1, wherein said any one of the roll-forming pairs (21, 22; 23, 24) is formed by the roll-forming pairs situated between the first and the last roll-forming pairs.

4. Roll-forming machine according to claim 1, wherein the measuring devices are measuring wheels (34, 35) in contact with the blank (11).

5. Method of roll-forming a fiat blank (11) into a product (12) with a bottom part (13) having a varying width and upright sides (14, 15) in two rows of roll-forming units each comprising one forming roll pair (21, 22; 23, 24), wherein
the vertical position of at least any one of the forming roll pairs is varied on either side during the roll-forming operation while the lateral and rotational positions thereof are simultaneously varied and the advance of the blank (11) is recorded, by measuring wheels (34, 35) which follow the vertical movements of the forming roll pairs.

6. Method according to claim 5, wherein the forming roll pairs (21, 22; 23, 24) situated between the first and the last roll-forming pairs are lowered while simultaneously being guided laterally in a convexly curved shape and/or these forming roll pairs are raised while simultaneously being guided laterally in a concavely curved shape.

7. Method according to claim 5, wherein that the last forming roll pair (21, 22; 23, 24) is raised on either side while simultaneously being guided laterally in a convexly curved shape and/or is lowered while simultaneously being guided laterally in a concavely curved shape.

8. Roll-forming machine according to claim 3, wherein the measuring devices are measuring wheels (34, 35) in contact with the blank (11).

9. Roll-forming machine according to claim 2, wherein the measuring devices are measuring wheels (34, 35) in contact with the blank (11).
